(19) United States
(12) Patent Application Publication
(10) Pub. No.: US 2023/0012796 A1
(43) Pub. Date: Jan. 19, 2023

(54) IDENTIFICATION OF A VEHICLE HAVING VARIOUS DISASSEMBLY STATES

(71) Applicant: 3M INNOVATIVE PROPERTIES COMPANY, St. Paul, MN (US)

(72) Inventors: Sophia S. Liu, St. Paul, MN (US); Andrew W. Long, Woodbury, MN (US); John W. Henderson, St. Paul, MN (US); Matthew D. Moore, Lake Elmo, MN (US); Esther S. Jeong, St. Paul, MN (US)

(21) Appl. No.: 17/866,159

(22) Filed: Jul. 15, 2022

Related U.S. Application Data
(60) Provisional application No. 63/222,662, filed on Jul. 16, 2021.

(51) Int. Cl. G06V 10/764; G06V 20/70; G06V 10/74

(52) U.S. Cl. CPC G06V 10/764; G06V 20/70; G06V 10/761; G06V 2201/08

(57) ABSTRACT

Aspects of the present disclosure relate to a method of identifying a vehicle, and a system thereof. The method can include receiving a first image of a vehicle from a first camera and classifying the vehicle in the first image with a vehicle class label. The method can also include determining a first vehicle fingerprint for the vehicle. The method can also include detecting any changes in the first vehicle fingerprint and the vehicle class label after a first time period. The detected changes in the first vehicle fingerprint can correspond to a disassembly state of the vehicle. The method can also include performing, if the vehicle class label is unchanged, at least one action in response to detected changes in the first vehicle fingerprint.

### BACKGROUND

The automotive collision repair industry can aim for efficiency and high vehicle throughput for a given repair facility. Numerous systems can calculate various performance metrics, both relevant to actionable shop improvements as well as improving standings with insurance providers in order to increase referral volumes. However, many shop systems may require manually inputting the underlying data such as the vehicle being in a service bay.

In order to extract the data used to calculate key performance metrics in a repair facility from passive video footage, vehicles in the camera footage can be identified and tied to an existing repair order in the repair facility. While identification of vehicles in images can occur using machine vision, vehicles in body shops are often heavily damaged, obscured by various masking products necessary for the repair process, or even missing key components such as bumpers, roofs, or doors. Which can make the identification of a damaged vehicle very difficult for standard computer vision algorithms to identify vehicles within a frame, let alone tie the vehicle to the correct repair order.

Some systems, such as found in U.S. Pat. App. Publication 20200104940 to Krishnan et. al. have contemplated using artificial intelligence to assess damage to vehicles and perform classification using machine learning, but not individual vehicle tracking within a repair facility in various states of disassembly/disrepair or matching the various states of disassembly/disrepair with the vehicle.

### BRIEF SUMMARY

Aspects of the present disclosure relate to a method of identifying a vehicle using a camera and a computer. The method can include receiving, with a computer, a first image of a vehicle from a first camera. The method can also include classifying, with the computer, the vehicle in the first image with a vehicle class label. The method can also include determining, with the computer, a first vehicle fingerprint for the vehicle. The first vehicle fingerprint can be a numerical representation of a plurality of nodal points and the first vehicle fingerprint can be associated with the vehicle class label or a plurality of vehicle class labels. The method can also include detecting, with a computer, any changes in the first vehicle fingerprint and the vehicle class label after a first time period. The detected changes in the first vehicle fingerprint can correspond to a disassembly state of the vehicle. The method can also include performing, if the vehicle class label is unchanged, at least one action (with the computer) in response to detected changes in the first vehicle fingerprint.

In at least one embodiment, classifying the vehicle can further include identifying an identification characteristic corresponding to the vehicle. Classifying the vehicle can further include determining a set of vehicles having the identification characteristic. The classification of the vehicle can use the set of vehicles to reduce potential vehicle class labels in response to determining the set of vehicles. The set of vehicles is a subset of a plurality of vehicles.

In at least one embodiment, the identification characteristic was not identified from the first image. For example, the identification characteristic was identified from a secondary device such as an RFID.

In at least one embodiment, performing at least one action can include updating a record in a data store corresponding to the vehicle. The method can also include determining a location label for the vehicle, and updating the record corresponding to the vehicle with the location label.

In at least one embodiment, performing at least one action can include updating the record corresponding to the vehicle or the vehicle class label with the disassembly state of the vehicle.

The method can also include determining whether the first vehicle fingerprint matches any of a plurality of stored vehicle fingerprints for the vehicle class label(s). In response to the first vehicle fingerprint not matching a stored vehicle fingerprint but matching the vehicle class label, the method can include updating the record corresponding to the vehicle class label with a disassembly state of the vehicle.

In at least one embodiment, detecting any changes in the first vehicle fingerprint further includes receiving a second image of the vehicle from the first camera, classifying the vehicle with the vehicle class label, and determining whether the vehicle class labels from the first image and the second image correspond to each other. In response to the vehicle class labels corresponding to each other, detecting any changes includes determining a second vehicle fingerprint for the vehicle, and detecting whether the second vehicle fingerprint is different from the first vehicle fingerprint.

In at least one embodiment, a first time period between the first image being captured and the second image being captured is at least 10 minutes.

In at least one embodiment, detecting whether the second vehicle fingerprint is different from the first vehicle fingerprint includes determining a similarity score between the first vehicle fingerprint and the second vehicle fingerprint. Detecting that the second vehicle fingerprint is different occurs in response to the similarity score being outside of a threshold.

In at least one embodiment, determining the first vehicle fingerprint includes identifying an anchor point on the vehicle, determining a plurality of nodal points on the vehicle from the anchor point, and calculating metrics between the plurality of nodal points to determine the first vehicle fingerprint.

Determining the first vehicle fingerprint can also include excluding the anchor point and/or plurality of nodal points from a modified area. Determining the first vehicle fingerprint can also include determining whether the anchor point is in a modified area using the vehicle class label and in response to the anchor point being in the modified area, moving the anchor point outside of the modified area.

The method can also include receiving a third image of the vehicle from a second camera in the repair facility. The third image is taken at a different angle from the first image and at the same time as the first image. The first vehicle fingerprint is determined from a composite of the first image and the third image. In at least one embodiment, the third image is subject to affine transformation to correspond to the first image.

In at least one embodiment, performing at least one action comprises communicating a disassembly state to shop management software and/or alerting a user of the disassembly state.

Aspects of the present disclosure relate to a non-transitory computer-readable storage medium including instructions that, when processed by a computer, configure the computer to perform any of the method of identifying a vehicle described herein.

Aspects of the present disclosure relate to a system including a processor and a memory storing instructions that, when executed by the processor, configure the computer to perform any of the method of identifying a vehicle described herein.

A system comprising a computer and a first camera. The computer includes a processor, and a memory storing instructions that, when executed by the processor, configure the computer to receive a first image of a vehicle from a first camera, classify the vehicle in the first image with a vehicle class label, determine a first vehicle fingerprint for the vehicle, the first vehicle fingerprint is a numerical representation of a plurality of nodal points and the first vehicle fingerprint is associated with the vehicle class label, detect any changes in the first vehicle fingerprint and the vehicle class label after a first time period, the detected changes in the first vehicle fingerprint correspond to a disassembly state of the vehicle, and perform, if the vehicle class label is unchanged, at least one action in response to detected changes in the first vehicle fingerprint.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a routine 100 in accordance with one embodiment.

FIG. 2 illustrates a subroutine block 200 in accordance with one embodiment.

FIG. 3 illustrates a subroutine block 300 in accordance with one embodiment.

FIG. 4 illustrates an exemplary system 400 in accordance with one embodiment.

FIG. 5 illustrates a subroutine block 500 in accordance with one embodiment.

FIG. 6 illustrates a subroutine block 600 in accordance with one embodiment.

FIG. 7 depicts an illustrative computer system architecture that may be used in accordance with one or more illustrative aspects described herein.

### DETAILED DESCRIPTION

Aspects of the present disclosure relate to a computer-implemented method of identifying a vehicle using a camera while its outward appearance is significantly altered during the course of its repair process.

Further aspects of the present disclosure can allow using the patterns in a vehicle body to add to a record of the vehicle (either during the normal course of the repair process or on an ad hoc basis) and unique identification markings to identify the vehicles and tie them to the correct repair orders in shop management software.

Thus, the data associated with the vehicle record can be populated into a shop management software in order to provide shop management software with the desired insights. An additional benefit of automating such a system is a reduction in manual data entry burden for shop administrators and workers, as well as an increase in data quality that can be leveraged downstream.

Computer software, hardware, and networks may be utilized in a variety of different system environments, including standalone, networked, remote-access (aka, remote desktop), virtualized, and/or cloud-based environments, among others.

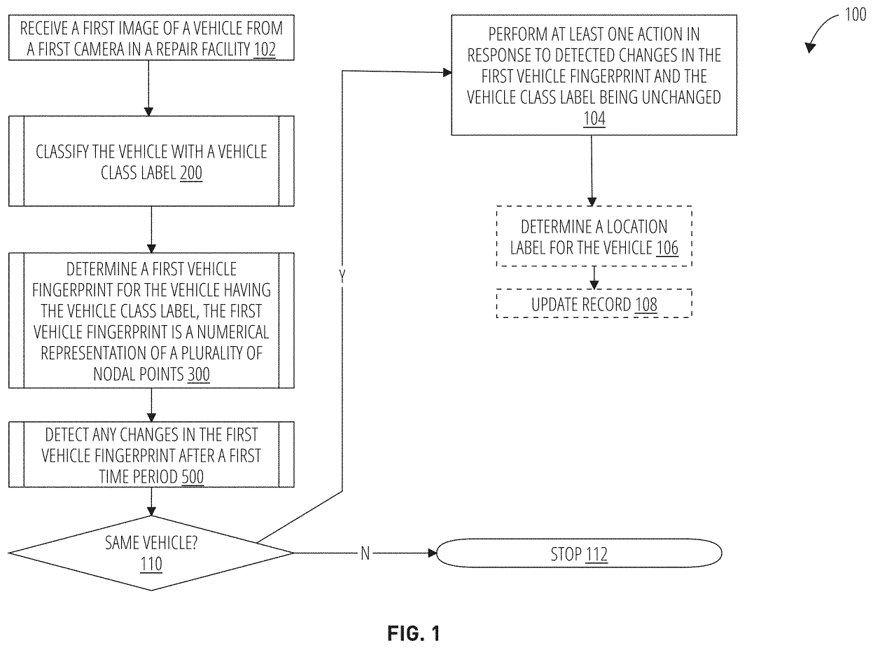

FIG. 1 illustrates a routine 100 that is executed by a computer. In block 102, routine 100 receives a first image of a vehicle from a first camera in a repair facility. The first image can be of the vehicle in a repair facility. The image can be of a resolution sufficient to perform aspects of the present disclosure and can depend on the lighting conditions therein. In at least one embodiment, the first image can undergo image preprocessing. For example, the first image can be standardized, augmented, or brightened or darkened.

In subroutine block 200, routine 100 can classify the vehicle with a vehicle class label. For example, the computer can use a deep learning algorithm that is trained to identify and classify the vehicle class label. In at least one embodiment, the vehicle can be detected using a deep learning algorithm. The deep learning algorithm can be a Convolutional Neural Network CNN, such as a Fast, or Faster CNN. In at least one embodiment, a deep learning algorithm can be trained on a set of images of different vehicles with different vehicle class labels to form a deep learning model that can be applied to unknown vehicles. For example, the images in the set can be of different vehicles with labels of their make, model, color, year, and any optional accessories. The vehicle class label can be used to partially identify the vehicle in the first image. However, the vehicle class label may be high level and the computer may not be able to locate the vehicle in various states of disassembly based on the vehicle class label alone.

In at least one embodiment, the vehicle class label can indicate that the object in the first image is an actual vehicle (such as a car, or a truck) and not, for example, a toy model. For example, the computer can determine that there is a vehicle depicted in this first image and which pixels relate to the vehicle or component thereof. The vehicle class label can be detected based on feature extraction. For example, based on a given image, the computer can determine that the object in the first image has high likelihood of being a vehicle. In at least one embodiment, the vehicle class label can be extracted from the first image (e.g., by masking the background).

In subroutine block 300, routine 100 determines a first vehicle fingerprint for the vehicle. The first vehicle fingerprint can be unique to the vehicle. The first vehicle fingerprint is a numerical representation of a plurality of nodal points. In at least one embodiment, the vehicle can have the vehicle class label that was determined in subroutine block 200. The plurality of nodal points can be unique for each vehicle class label. For example, the nodal points for a first make and model of vehicle can be different from nodal points for a second make and model of vehicle. The subroutine block 300 is described further herein.

In at least one embodiment, the first vehicle fingerprint can be determined based on points that are unlikely to change. An example of determining a vehicle fingerprint can be found in Ding et. al., Vehicle Pose and Shape Estimation through Multiple Monocular Vision, 11 Nov. 2018, available at https://arxiv.org/pdf/1802.03515.pdf. In at least one embodiment, the first vehicle fingerprint can be linked to a data store of shop management software in order to assign the nodal points or anchor point. For example, if the vehicle enters the repair facility with damage to the front bumper, and front passenger fender, then the anchor point and subsequent nodal points can be selected that do not include areas of damage (i.e., front bumper, front passenger fender).

In at least one embodiment, multiple cameras can be used to determine the vehicle fingerprint. For example, the computer can receive a third image of the vehicle from a second camera in the repair facility. The third image can be taken at a different angle from the first image and/or at the same time as the first image. The multiple images can be used to produce a composite image which can be used to determine a vehicle fingerprint. In at least one embodiment, the third image can be subject to affine transformation to correspond to the first image. For example, affine and/or linear transformations can be used to align a vehicle that has been moved within the space.

In at least one embodiment, the vehicle fingerprint can be independently determined for each image (in an image set) and then averaged together to produce a composite vehicle fingerprint value.

After the vehicle fingerprint is determined in subroutine block 300, then in subroutine block 500, routine 100 detects any changes in the first vehicle fingerprint after a first time period. The changes can occur based on the vehicle moving to a different location (which may impact the shadowing) or having component parts being replaced, repaired, or changed on the vehicle. If there are changes to the underlying vehicle fingerprint or vehicle class label, then the routine 100 can continue to decision block 110.

In decision block 110, the computer can determine whether the vehicle is the same vehicle. In at least one embodiment, the computer can implement decision block 110 in any order within routine 100. For example, decision block 110 can occur after subroutine block 200.

In at least one embodiment, the vehicle can be the same vehicle when a first instance of the vehicle has at least some of the same vehicle class labels as the second instance of the vehicle. In at least one embodiment, the vehicle can be the same vehicle if the vehicle fingerprints from the first instance (first image) correspond to that of a second instance (second image). For example, if the vehicle fingerprint is outside of a threshold, then the vehicle may not be the same vehicle received in block 102. In at least one embodiment, the vehicle can be determined based on an isolated location on the vehicle, e.g., the shape and dimensions of windshield glass. If the vehicle fingerprint values for the isolated location differs in subroutine block 500 past a threshold, then the computer can determine that the vehicle is not the same vehicle and the routine 100 stops in done block 112. In at least one embodiment, the routine 100 can continue to block 102 for further analysis with the new vehicle.

In block 104, routine 100 performs at least one action in response to detected changes in the first vehicle fingerprint and the vehicle class label(s) being the same/unchanged. For example, if the vehicle class label is unchanged, the routine 100 can perform at least one action in response to detected changes in the first vehicle fingerprint. In at least one embodiment, the vehicle class label(s) can be unchanged if the vehicle class label(s) corresponds to the vehicle class label(s) from a previous instance (e.g., a previous image or a previous vehicle as described herein).

The action can be related to a data store operation related to the shop management software. For example, the action can include updating a record corresponding to the vehicle and the vehicle class label with an assembly/disassembly state of the vehicle. The action can also be related to communicating the disassembly state to shop management software. In at least one embodiment, the action can include alerting a user of the assembly/disassembly state of the vehicle. For example, the computer can communicate with the user (such as a vehicle owner), what is being repaired at the repair facility in real-time without technician intervention. In at least one embodiment, the changes of the vehicle fingerprint can indicate that a part on the vehicle has been repaired and the repaired part can be communicated to the shop management software.

In at least one embodiment, the action can be initiating a timer. For example, the computer can initiate a timer between vehicle fingerprints which can correspond to a time a technician takes to complete a given task.

In block 106, the routine 100 can determine a location label for the vehicle. The location label can indicate where the vehicle is located within the repair facility. For example, the location label can indicate that the vehicle was detected in “Bay One”. The location label can correspond to a location of the frame (e.g., if the video frame indicates that any vehicle in the frame is in a particular repair bay).

The record can in updated in block 108 with the location label. As the vehicle becomes more repaired (i.e., the vehicle fingerprint changes), then the record can update with the location label and the vehicle fingerprint and/or vehicle disassembly state. This record can also be appended with data describing the technician.

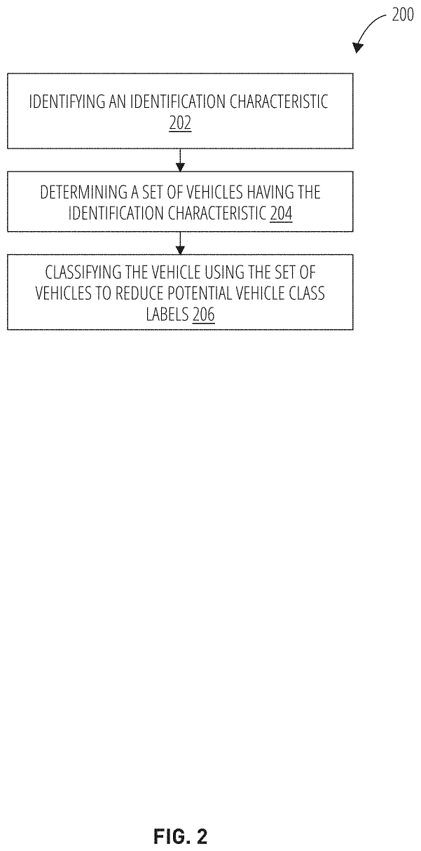

FIG. 2 illustrates subroutine block 200 which is a method of classifying the vehicle using identification characteristics prior to the determination of vehicle class labels. For example, identification characteristics can be used to narrow down a list of potential vehicle class labels based on data within a data store. The potential vehicle class label refers to a vehicle class label that has not been assigned by the computer but could be.

In block 202, the computer can identify an identification characteristic corresponding to the vehicle. The identification characteristic does not need to be determinable from the first image or the camera. For example, the identification characteristic can include computer readable codes such as barcodes, QR codes, or RFID tags that are linked to a data store of all vehicles in a repair facility. In at least one embodiment, the identification characteristic can be a written code (such as an identification number or unique inventory number) written on a sticker and attached to the vehicle. The written code can be referenced in the data store and retrieved by the computer.

In block 204, the computer can determine a set of vehicles having the identification characteristic. For example, the computer can access a data store of identification characteristics and the vehicles within the data store. In one example, the set of vehicles can be a group of vehicles that can potentially have the identification characteristic. In at least one embodiment, the set of vehicles can be a subset of a plurality of vehicles in the repair facility or referenced in the data store. For example, if the identification characteristic is a written note describing the date that the vehicle was checked-in, then multiple vehicles could have the same identification characteristic. In at least one embodiment, a single vehicle in the repair facility can have the identification characteristic.

In block 206, the computer can classify the vehicle using the set of vehicles to reduce potential vehicle class labels in response to determining the set of vehicles. For example, if the identification characteristic identifies a vehicle, then the computer can classify the vehicle using the data store. The data store can contain additional information usable by the computer to populate the vehicle class label for the vehicle. For example, if the vehicle having the identification characteristic is found in the data store has a make and model, then the make and model can be used as vehicle class labels for the vehicle.

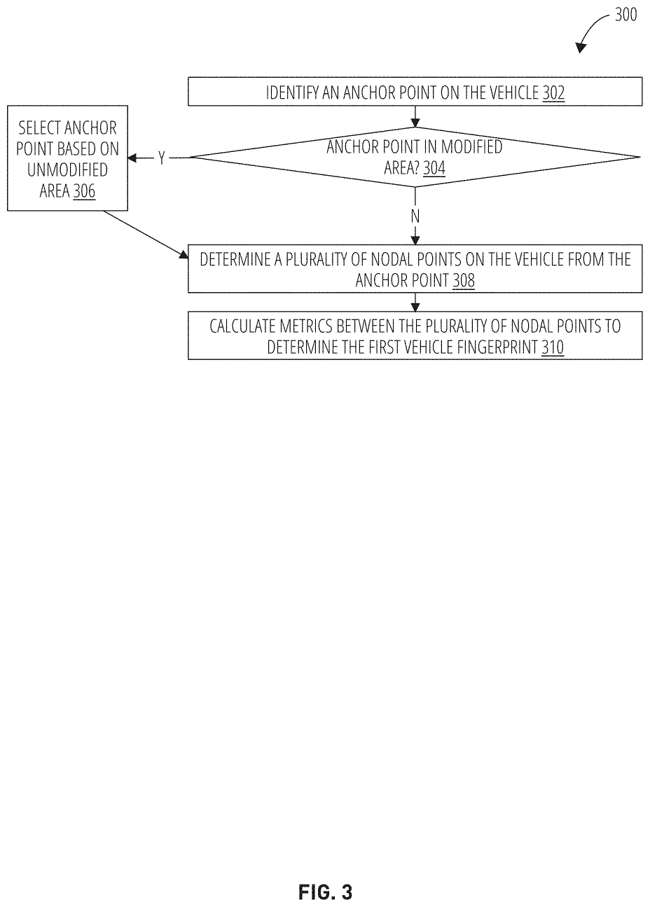

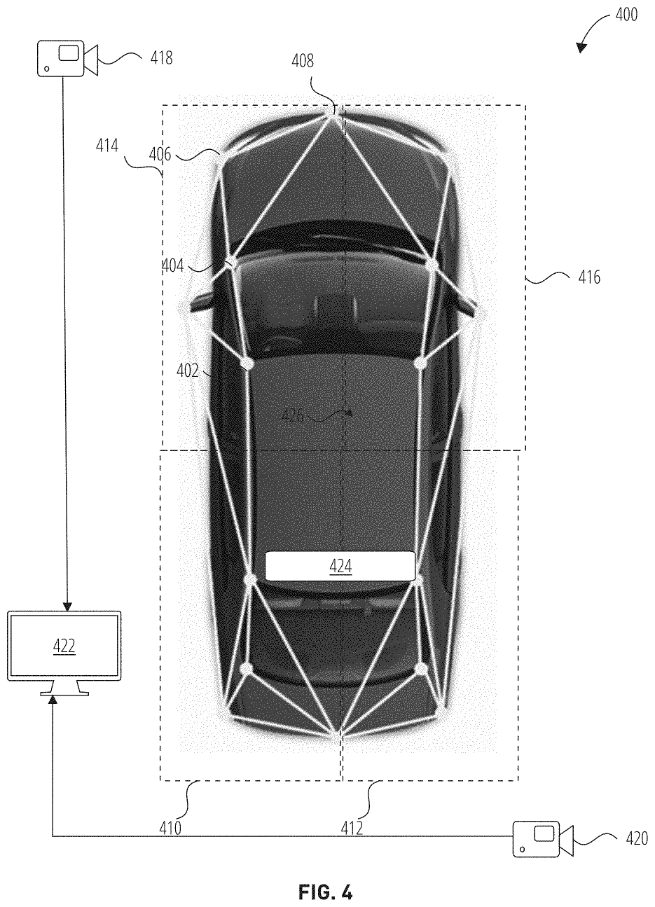

FIG. 3 illustrates a subroutine block 300 referring to a method of determining vehicle fingerprints for a vehicle. Subroutine block 300 can be further illustrated in conjunction with FIG. 4. For example, FIG. 4 illustrates a system 400 that includes a vehicle 426, a camera 418 and a camera 420. In at least one embodiment, the repair facility can be outfitted with a plurality of cameras (e.g., camera 418, camera 420) on the shop floor. The plurality of cameras can be positioned at different angles to capture different perspectives. For example, angle from camera 418 can include 20 landmarks while camera 420 can have fewer landmark features. The feature set can be combined by creating different data subsets for each camera angles.

The camera 418 and camera 420 can be communicatively coupled to the computer 422 which can perform the subroutine block 300 described herein. In at least one embodiment, the vehicle fingerprint can be established by a single camera.

In block 302, the computer 422 can identify an anchor point 402 on the vehicle. The anchor point can be based on landmark features on the vehicle (e.g., a hood emblem) or a non-symmetric point such as a non-damaged area in a vehicle with front-end damage. In at least one embodiment, glass markers from a technician (indicating damage) can be used to form the anchor point 402. In another embodiment, high-contrast points on the body can be used as anchor point 402 (e.g., a boundary between different parts such as a hood and a grill of the vehicle. In at least one embodiment, the anchor point 402 can be determined using edge finding, or corner rendering. In at least one embodiment, the anchor point 402 can be established based on a likelihood of being damaged. For example, if vehicles do not typically have damage to the roofline (determinable from a data store of vehicle collision data), then the computer 422 can select the anchor point 402 across all vehicles.

In decision block 304, the computer 422 can determine whether the anchor point identified is in a modified area of the vehicle 426. For example, the modified area can be an area that differs from a known (e.g., stock) configuration of the vehicle 426.

In at least one embodiment, the modified area can be based on one or more vehicle class labels (e.g., determined in subroutine block 200). For example, one of the vehicle class labels for the vehicle may indicate damage to a front bumper (that may be determinable by the computer from a data store). The computer can exclude the anchor point (and/or any of the nodal points) from the modified area.

In at least one embodiment, the modified area can be detected using a known vehicle fingerprint for a known make and model of vehicle in a data store. The modified area can be an area that has sustained damage within the vehicle (e.g., if the vehicle was involved in a front-end collision). In at least one embodiment, the damaged area (i.e., modified area) of the vehicle 426 can be determined using shop management software. For example, natural language processing of the notes in the shop management software can reveal that a vehicle has sustained only front-end damage, thus, making the rear end of the vehicle unmodified.

If the anchor point 402 is in a modified area, then the computer 422 can select an anchor point that is in an unmodified area of the vehicle (e.g., an undamaged portion of the vehicle) in block 306. In at least one embodiment, this anchor point can be consistent across all instances of vehicle fingerprints for the vehicle.

In block 308, subroutine block 300 determines a plurality of nodal points on the vehicle from the anchor point. The anchor point can be another node within a graph. The nodal points can be derived from the anchor point 402. The nodal points can be selected based on the proximity to the anchor point 402, the contrast between surfaces, the edge of the surface, and combinations thereof.

In at least one embodiment, a “bird's eye view” of a vehicle can be segmented into zones (as described herein). The vehicle can have landmarks such as rearview mirrors, the nose of the car, the tail of the car, the edges of the from windshield, etc. The various landmarks can form nodal points for which the distances between various nodal points create a “fingerprint” that can be used to identify the vehicle. When a vehicle is severely damaged the nodal point distances will change significantly. As it is highly improbable that two vehicles of the same make and model sustaining the same damage will be in a repair facility at the same time, the nodal point distances can be unique to each vehicle in the repair facility.

As shown, the vehicle 426 is logically divided into 4 zones/quadrants (zone 414, zone 416, zone 410, and zone 412). In at least one embodiment, the zones can be established based on symmetry with another zone. Thus, if zone 416 is damaged, then zone 414 can include the anchor point 402. An aspect of the present disclosure is the selection of the anchor point 402 based on the exclusion of one or more zones using data from a data store indicating the damage to the vehicle 426. In at least one embodiment, the nodal points can be consistent across all instances of vehicle fingerprints for the vehicle.

Proximate to anchor point 402 are nodal point 404, nodal point 406, and nodal point 408. These nodal points can be selected based on contrast points and edges established by the vehicle 426 body. For example, nodal point 408 can be established by the emblem of the vehicle 426. The nodal point 406 can be established by the headlight of the vehicle 426. The nodal point 404 can be established by the interface between the windshield and the base of the driver's side pillar.

In at least one embodiment, a vehicle fingerprint can be a numerical relationship between any of the plurality of nodal points. In block 310, subroutine block 300 calculates metrics between the plurality of nodal points to determine the first vehicle fingerprint. The metrics can include the anchor point as the focal point or can be the distance between (non-anchor) nodal points. For example, the distance between anchor point 402 and nodal point 404, nodal point 406, and nodal point 408 can each form the vehicle fingerprint for vehicle 426.

In at least one embodiment, ratios between the plurality of nodal points can be used. For example, the ratio of the distance of anchor point 402 and nodal point 404 to the distance of anchor point 402 to nodal point 406.

In at least one embodiment, a vehicle fingerprint can also be based on pattern recognition and the ability of a deep learning algorithm to perform pattern recognition on any of the zones. For example, the vehicle fingerprint can be based on feature matching as described in https://docs.opencv.org/master/d1/de0/tutorial_py_feature_homography.html.

During the repair process, parts of the vehicle can be removed, altering the nodal point distances associated with a given vehicle. When the nodal point distances of a vehicle changes above a certain threshold value within a certain time frame, the identifying nodal point distances for a given vehicle can be updated in the data store and the new nodal point distances can be used to identify the vehicle.

In at least one embodiment, the vehicle 426 can be masked with tape 424. The masking could obscure certain focal points on the vehicle. When this occurs, the highest contrast nodal points on the vehicle (after segmentation) can be used as focal points. The nodal points can also be established by the tape 424 or masking products that are used on the vehicle 426 at a given time. Since it is very unlikely that vehicles will be masked in the exact same way, the new focal point distances will be uniquely identifying to a specific vehicle in the shop.

In at least one embodiment, radio frequency identification (RFID) and other sensor-based devices (i.e., identification characteristic, as described in subroutine block 200) can also be place on the vehicle 426 to track it through the repair facility. However, there could be situations where there is not an adequate place on the vehicle to place the senor.

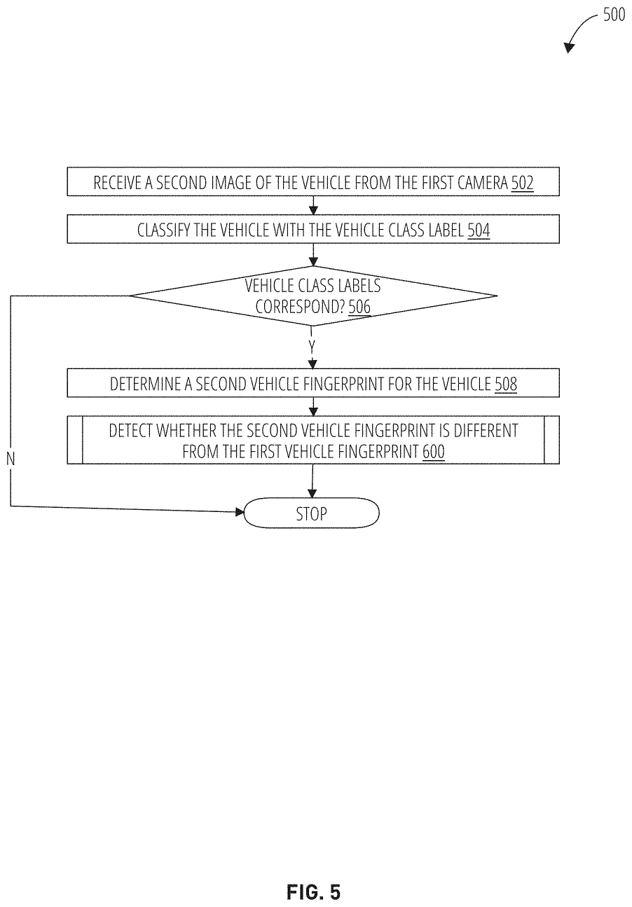

FIG. 5 illustrates a subroutine block 500 for detecting any changes in the vehicle fingerprint after a first time period.

In at least one embodiment, the computer, in block 502, can receive a second image of the vehicle from the first camera or a second camera. However, for ease of framing the vehicle, the first camera can be used to approximate the frame of the first image.

In block 504, the computer can classify the vehicle with the vehicle class label as described in subroutine block 200. For example, the computer can determine the vehicle class label based on the second image from the camera prior performing any determination of the vehicle fingerprint. The classification can occur similar to subroutine block 200.

In decision block 506, the computer can determine if the vehicle class labels from the second image correspond to the vehicle class labels from the first image. The vehicle class labels can correspond if a threshold (e.g., a majority, or all) of vehicle class labels are the same. For example, if both vehicle class labels include “dodge” and “caravan”, then the vehicle class labels can correspond to each other. In another example, if both vehicle class labels include the same make and model class labels, but differ in the color, then the vehicle class labels do not correspond with each other. If the vehicle class labels do not correspond, then the subroutine block 500 can stop and the computer can determine that the vehicle from the first image is not the same vehicle from the second image while avoiding the use of additional computational resources.

In block 508, the computer can determine a second vehicle fingerprint for the vehicle. In at least one embodiment, the vehicle fingerprint can be determined according to subroutine block 300.

In subroutine block 600, the computer can detect whether the second vehicle fingerprint is different from the first vehicle fingerprint. The second vehicle fingerprint can be different from the first vehicle based on a numerical difference in the metrics. In at least one embodiment, the second vehicle fingerprint can be different from the first vehicle fingerprint based on the deep learning algorithm. For example, the computer can determine that vehicle in the second image is correlated to the vehicle in the first image.

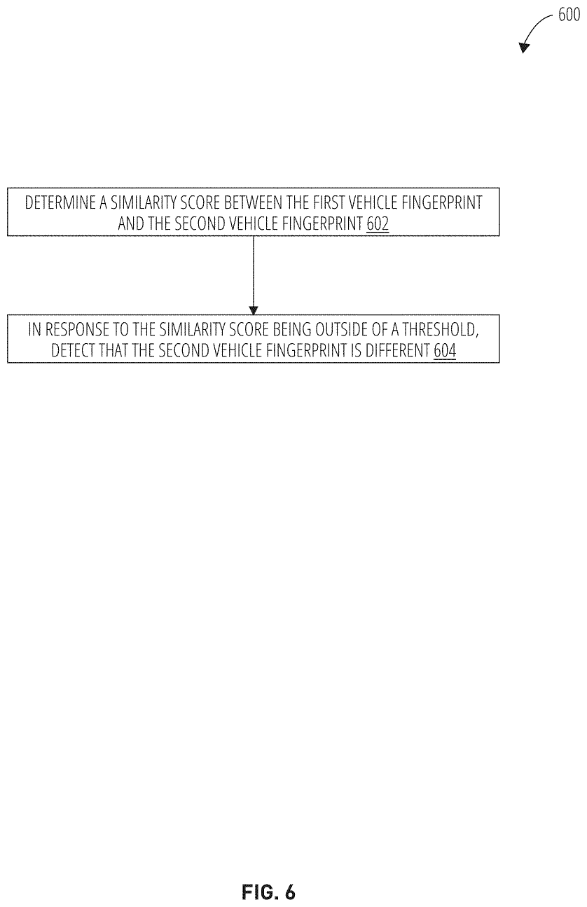

FIG. 6 illustrates a subroutine block 600 for a computer detecting a difference between two vehicle fingerprints.

In block 602, the computer can determine a similarity score between the first vehicle fingerprint and the second vehicle fingerprint. The similarity score can be a numerical correlation between two vehicle fingerprints. For example, if the vehicle fingerprint is the ratio of distance between two points, then the similarity score can be based on a threshold value of the ratio. If the vehicle fingerprint is based on a plurality of nodal points, then the plurality of nodal points can collectively form a graph in which the similarity score can be determined using techniques for solving the subgraph isomorphism problem. In at least one embodiment, block 602 can be determined using deep learning techniques to produce a likelihood that a first vehicle is the same as a second vehicle.

If at any time the computer determines that the vehicle fingerprint is the same as one that is previously stored (e.g., the second vehicle fingerprint has a high similarity score with the first vehicle fingerprint), then the record can be updated in the data store with the location label. For example, the vehicle may have been moved, but otherwise unmodified from the first instance. Thus, resources can be saved if some aspects of subroutine block 500 are avoided.

In block 604, the computer can detect that the second vehicle fingerprint is different from the first vehicle fingerprint if the similarity score threshold is not met. For example, if the similarity score is a ratio of two measurements, then the similarity score threshold is not met when the similarity score is greater or lower than the threshold.

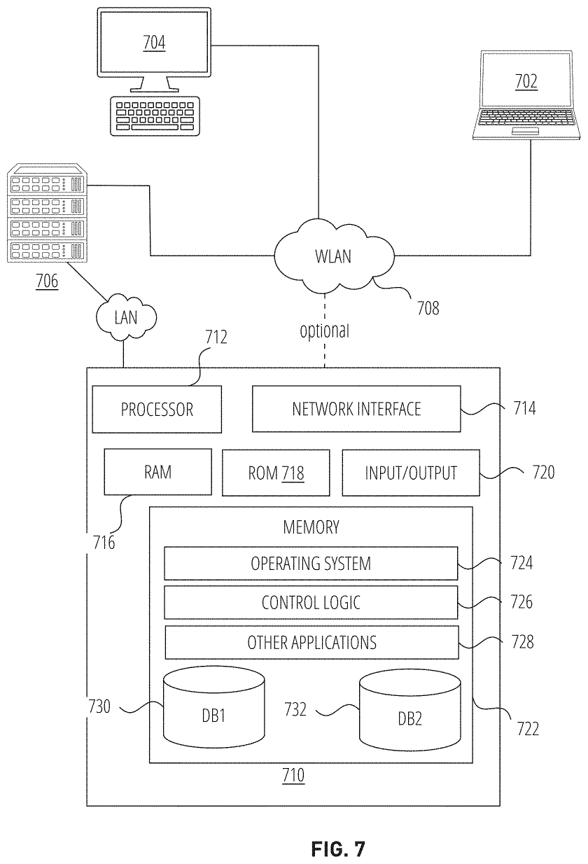

FIG. 7 illustrates one example of a system architecture and data processing device that may be used to implement one or more illustrative aspects described herein in a standalone and/or networked environment. Various network nodes computer 710, web server 706, computer 704, and laptop 702 may be interconnected via a wide area network 708 (WAN), such as the internet. Other networks may also or alternatively be used, including private intranets, corporate networks, LANs, metropolitan area networks (MANs) wireless networks, personal networks (PANs), and the like. Network 708 is for illustration purposes and may be replaced with fewer or additional computer networks. A local area network (LAN) may have one or more of any known LAN topology and may use one or more of a variety of different protocols, such as ethernet. Devices computer 710, web server 706, computer 704, laptop 702 and other devices (not shown) may be connected to one or more of the networks via twisted pair wires, coaxial cable, fiber optics, radio waves or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include computer 710, web server 706, and client computer 704, laptop 702. computer 710 provides overall access, control and administration of databases and control software for performing one or more illustrative aspects described herein. Computer 610 may be connected to web server 706 through which users interact with and obtain data as requested. Alternatively, computer 710 may act as a web server itself and be directly connected to the internet. computer 710 may be connected to web server 706 through the network 708 (e.g., the internet), via direct or indirect connection, or via some other network. Users may interact with the computer 710 using remote computer 704, laptop 702, e.g., using a web browser to connect to the computer 710 via one or more externally exposed web sites hosted by web server 706. Client computer 704, laptop 702 may be used in concert with computer 710 to access data stored therein, or may be used for other purposes. For example, from client computer 704, a user may access web server 706 using an internet browser, as is known in the art, or by executing a software application that communicates with web server 706 and/or computer 710 over a computer network (such as the internet).

Servers and applications may be combined on the same physical machines, and retain separate virtual or logical addresses, or may reside on separate physical machines. FIG. 7 illustrates just one example of a network architecture that may be used, and those of skill in the art will appreciate that the specific network architecture and data processing devices used may vary, and are secondary to the functionality that they provide, as further described herein. For example, services provided by web server 706 and computer 710 may be combined on a single server.

Each component computer 710, web server 706, computer 704, laptop 702 may be any type of known computer, server, or data processing device. computer 710, e.g., may include a processor 712 controlling overall operation of the computer 710. computer 710 may further include RAM 716, ROM 718, network interface 714, input/output interfaces 720 (e.g., keyboard, mouse, display, printer, etc.), and memory 722. Input/output interfaces 720 may include a variety of interface units and drives for reading, writing, displaying, and/or printing data or files. Memory 722 may further store operating system software 724 for controlling overall operation of the computer 710, control logic 726 for instructing computer 710 to perform aspects described herein, and other application software 728 providing secondary, support, and/or other functionality which may or may not be used in conjunction with aspects described herein. The control logic may also be referred to herein as the data server software control logic 726. Functionality of the data server software may refer to operations or decisions made automatically based on rules coded into the control logic, made manually by a user providing input into the system, and/or a combination of automatic processing based on user input (e.g., queries, data updates, etc.).

Memory 622 may also store data used in performance of one or more aspects described herein, including a first data store 732 and a second data store 730. In some embodiments, the first database may include the second database (e.g., as a separate table, report, etc.). That is, the information can be stored in a single database, or separated into different logical, virtual, or physical databases, depending on system design. Web server 706, computer 704, laptop 702 may have similar or different architecture as described with respect to computer 710. Those of skill in the art will appreciate that the functionality of computer 710 (or web server 706, computer 704, laptop 702) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a nonvolatile storage device. Any suitable computer readable storage media may be utilized, including hard disks, CD-ROMs, optical storage devices, magnetic storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). various aspects described herein may be embodied as a method, a data processing system, or a computer program product. Therefore, various functionalities may be embodied in whole or in part in software, firmware and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

“Anchor point” refers to a location on a vehicle that is consistently determined.

“Data store” refers to repository for persistently storing and managing collections of data. This can include databases and other file types.

“Disassembly state” refers to a status of disrepair or disassembly of a vehicle. The disassembly state can refer to the damage sustained by the vehicle including the location of the damage, any stage of reassembly of a vehicle, or can refer to the parts removed from the vehicle.

“Identification characteristic” refers to a feature that enables specific identification of the vehicle (e.g., when in communication with a data store). In at least one embodiment, the identification characteristic may avoid the use of machine vision.

“Image” refers to a still image or part of a moving sequence of images initially captured by a camera.

“Location label” refers to location of the vehicle within a repair facility. Specifically, a location label can refer to an expected position of the vehicle. In at least one embodiment, the location label can be related to the frame of an image.

“Nodal point” refers to a location on the vehicle that is identified based off of proximity to the anchor point. The nodal point can be used to indicate the vehicle fingerprint.

“Repair facility” refers to an area where vehicles are repaired or stored prior to repair or after becoming repaired. For example, a repair facility can include both a building and a lot surrounding the repair facility.

“Shop management software” refers to a software product that manages activities of a repair facility such as invoicing, inspection, customer relationship management, workflow, and inventory. For example, the shop management software can communicate repair status to a customer.

“Vehicle class label” refers to an indication relating to a vehicle. For example, the vehicle class label can be an indication that the vehicle belongs to a “vehicle” class (i.e., that the vehicle is actually a vehicle). The vehicle class label can also be a category that can distinguish vehicles in a location from other vehicles in other locations. This could be any combination of the features; make, model, color, and distinguishable markings on the vehicle (e.g., bumper stickers or damage).

“Vehicle fingerprint” refers to a unique identifier of a vehicle that are determined using a machine vision. The vehicle fingerprint can be based on scale-invariant feature transform (SIFT) features, or other point detection algorithms to determine anchor points, or nodal points within a vehicle body including body panels, bumper covers, fenders, chassis or frame member.

What is claimed is:

1. A method comprising:
receiving a first image of a vehicle from a first camera;
classifying the vehicle in the first image with a vehicle class label;
determining a first vehicle fingerprint for the vehicle, the first vehicle fingerprint is a numerical representation of a plurality of nodal points and the first vehicle fingerprint is associated with the vehicle class label;
detecting any changes in the first vehicle fingerprint and the vehicle class label after a first time period, the detected changes in the first vehicle fingerprint correspond to a disassembly state of the vehicle; and
performing, if the vehicle class label is unchanged, at least one action in response to detected changes in the first vehicle fingerprint.

2. The method of claim 1, wherein classifying the vehicle further comprises:
identifying an identification characteristic corresponding to the vehicle, determining a set of vehicles having the identification characteristic; and
classifying the vehicle using the set of vehicles to reduce potential vehicle class labels in response to determining the set of vehicles, wherein the set of vehicles is a subset of a plurality of vehicles.

3. The method of claim 2, wherein the identification characteristic was not identified from the first image.

4. The method of claim 2, wherein the identification characteristic is a unique inventory number.

5. The method of claim 1, wherein performing at least one action comprises:
updating a record in a data store corresponding to the vehicle.

6. The method of claim 5, further comprising:
determining a location label for the vehicle; and
updating the record corresponding to the vehicle with the location label with the disassembly state of the vehicle.

7. The method of claim 5, further comprising:
determining whether the first vehicle fingerprint matches any of a plurality of stored vehicle fingerprints for the vehicle class label;
in response to the first vehicle fingerprint not matching a stored vehicle fingerprint but matching the vehicle class label, updating the record corresponding to the vehicle class label with the disassembly state of the vehicle.

8. The method of claim 5, wherein detecting any changes in the first vehicle fingerprint further comprises:
receiving a second image of the vehicle from the first camera;
classifying the vehicle with the vehicle class label using the second image;
determining whether the vehicle class label from the first image corresponds to the vehicle class label from the second image;
determining, in response to the vehicle class labels corresponding to each other, a second vehicle fingerprint for the vehicle; and
detecting whether the second vehicle fingerprint is different from the first vehicle fingerprint.

9. The method of claim 8, wherein detecting whether the second vehicle fingerprint is different comprises:
determining a similarity score between the first vehicle fingerprint and the second vehicle fingerprint;
in response to the similarity score being outside of a threshold, detecting that the second vehicle fingerprint is different.

10. The method of claim 1, wherein determining the first vehicle fingerprint comprises:
identifying an anchor point on the vehicle;
determining a plurality of nodal points on the vehicle from the anchor point;
calculating metrics between the plurality of nodal points to determine the first vehicle fingerprint.

11. The method of claim 10, wherein determining the first vehicle fingerprint comprises:
determining whether the anchor point is in a modified area using the vehicle class label;
in response to the anchor point being in the modified area, moving the anchor point outside of the modified area.

12. The method of claim 1, further comprising:
receiving a third image of the vehicle from a second camera in a repair facility, wherein the third image is taken at a different angle from the first image and at a same time as the first image;
wherein the first vehicle fingerprint is determined from a composite of the first image and the third image.

13. The method of claim 12, wherein the third image is subject to affine transformation to correspond to the first image.

14. A non-transitory computer-readable storage medium including instructions that, when processed by a computer, configure the computer to perform the method of claim 1.

15. A system comprising:
a computer, comprising:
a processor; and
a memory storing instructions that, when executed by the processor, configure the computer to:
receive a first image of a vehicle from a first camera;
classify the vehicle in the first image with a vehicle class label;
determine a first vehicle fingerprint for the vehicle, the first vehicle fingerprint is a numerical representation of a plurality of nodal points and the first vehicle fingerprint is associated with the vehicle class label;
detect any changes in the first vehicle fingerprint and the vehicle class label after a first time period, the detected changes in the first vehicle fingerprint correspond to a disassembly state of the vehicle; and
perform, if the vehicle class label is unchanged, at least one action in response to detected changes in the first vehicle fingerprint.

16. The system of claim 15, wherein classifying the vehicle further comprises:
identify an identification characteristic corresponding to the vehicle,
determine a set of vehicles having the identification characteristic; and
classify the vehicle using the set of vehicles to reduce potential vehicle class labels in response to determining the set of vehicles, wherein the set of vehicles is a subset of a plurality of vehicles.

17. The system of claim 15, wherein the instructions further configure the computer to:
determine whether the first vehicle fingerprint matches any of a plurality of stored vehicle fingerprints for the vehicle class label;
in response to the first vehicle fingerprint not matching a stored vehicle fingerprint but matching the vehicle class label, updating a record corresponding to the vehicle class label with the disassembly state of the vehicle.

18. The system of claim 15, wherein the instructions further configure the computer to:
receive a second image of the vehicle from the first camera;
classify the vehicle with the vehicle class label using the second image;
determine whether the vehicle class label from the first image corresponds to the vehicle class label from the second image;
determine, in response to the vehicle class labels corresponding to each other, a second vehicle fingerprint for the vehicle; and
detect whether the second vehicle fingerprint is different from the first vehicle fingerprint.

19. The system of claim 18, wherein detecting whether the second vehicle fingerprint is different comprises:
determine a similarity score between the first vehicle fingerprint and the second vehicle fingerprint;
in response to the similarity score being outside of a threshold, detect that the second vehicle fingerprint is different.

20. The system of claim 15, wherein determining the first vehicle fingerprint comprises:
identify an anchor point on the vehicle;
determine a plurality of nodal points on the vehicle from the anchor point;
calculate metrics between the plurality of nodal points to determine the first vehicle fingerprint.
